(19) United States
(12) Patent Application Publication
(10) Pub. No.: US 2015/0302684 A1
(43) Pub. Date: Oct. 22, 2015

(54) GAMING MACHINE WITH ENHANCED AUDIO INTERFACE FUNCTIONALITY

(71) Applicant: WMS Gaming Inc., Waukegan, IL (US)

(72) Inventors: Timothy C. Loose, Chicago, IL (US); Scot W. Salzman, Buffalo Grove, IL (US); Jacob C. Greenburg, Elgin, IL (US); Craig J. Sylla, Round Lake, IL (US)

(21) Appl. No.: 14/687,217

(22) Filed: Apr. 15, 2015

Related U.S. Application Data
(60) Provisional application No. 61/980,162, filed on Apr. 16, 2014.

(51) Int. Cl. G07F 17/32

(52) U.S. Cl. CPC G07F 17/3213; G07F 17/3216

(57) ABSTRACT

Systems and methods for configuring a gaming machine through its audio jack. The audio jack is located behind a locked access door in a cabinet of the gaming machine. An external device connects to the audio jack through the access door and downloads an audio file to the gaming machine. The audio file is encoded with configuration information including configuration settings and corresponding values or parameters for the target gaming machine. When the file transfer is complete, an optional graphical user interface displayed on the gaming machine or on the external device allows the operator to accept a group of configuration settings or to selectively change user-selectable configuration settings. A group of default configuration settings embedded in the configuration information can be automatically applied to the affected hardware or software components of the gaming machine.

### CROSS-REFERENCE TO RELATED APPLICATION

This application claims the benefit of U.S. Provisional Patent Application No. 61/980,162, filed Apr. 16, 2014, entitled “Gaming Machine with Enhanced Audio Interface Functionality”.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present disclosure relates generally to wagering games, and methods for playing wagering games, and more particularly, to a wagering game in which a bonus event is triggered, revealing a bonus award show during which bonus awards are eliminated, one at a time, until the winning bonus award is revealed.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

Configuration of gaming machines can be a time-intensive, error-prone process, requiring the operator to drill through multiple menus. If the operator makes a mistake during the configuration procedure, a memory clear function must be performed, and the gaming machine rebooted, a process that can take several minutes.

### SUMMARY OF THE INVENTION

According to one aspect of the present disclosure, a gaming machine is disclosed that includes: a cabinet having a locked access door; one or more input devices; one or more display devices; an audio jack accessible externally from the gaming machine through the locked access door, the audio jack having at least a microphone input conductor receiving an input from an external audio plug; game-logic circuitry, comprising one or more central processing units and one or more memory devices. The one or more memory devices store non-transitory machine-readable instructions that, when executed by the one or more central processing units, cause the game-logic circuitry to: receive, via at least one of the one or more input devices, an input indicative of a wager; responsive to a criterion being satisfied, receive, through the audio jack, configuration information from a device external to the gaming machine to configure one or more components of the gaming machine, the components including a hardware component and a software component both associated with the gaming machine or with a wagering game playable on the gaming machine; and responsive to receiving the configuration information through the audio jack, configure the one or more components according to the received configuration information.

The configuration information can be encoded using an audio lossy compression encoding format and contained in a single file. The game-logic circuitry can allow the configuration information to be received through the audio jack but no information can be transmitted to the gaming machine from an external device that sent the configuration information during the configuration of the hardware or software component.

The configuration information can be received through an audio cable connected to the audio jack. The one or more central processing units can further cause the game-logic circuitry to display on the one or more display devices a configuration setting associated with the received configuration information and a prompt to enter a value or a parameter for the configuration setting via the one or more input devices.

The configuration information can include a configuration setting and a corresponding value or parameter associated with the configuration setting. The configuration setting can include a line count setting indicating a number of lines of symbols to be displayed on the wagering game, a payline setting indicating lines in a matrix of symbols of the wagering games used to determine winning combinations of symbols, a theme setting indicating a theme of the wagering game, a bonus round setting indicating content to be provided when the wagering game triggers a bonus round, an episodic content setting indicating content associated with episodes of a bonus round of the wagering game or of the wagering game, an attract content setting indicating content to be presented when the wagering game is idle to attract players to the gaming machine, a denomination setting indicating an amount of a wager required for a single game play of the wagering game, a pay table setting indicating a table to determine a payout of the wagering game responsive to a game outcome of the wagering game corresponding to a winning outcome, a maximum wager amount setting indicating a maximum amount of the wager on a round of game play of the wagering game, a progressive game setting indicating which progressive game the wagering game participates in, or a play mechanic setting indicating a presentation of aspects of how the wagering game is to be played.

The one or more components can include a plurality of components. The received configuration information can include a plurality of default settings associated with the gaming machine and a user-selectable setting. The one or more central processing units can further cause the game-logic circuitry to configure at least some of the plurality of components according to the default settings and to display on the one or more display devices a prompt to enter a value or a parameter for the user-selectable setting via the one or more input devices.

The one or more central processing units can further cause the game-logic circuitry to determine whether the locked access door is unlocked prior to receiving the configuration information. Responsive to the game-logic circuitry determining that the locked access door is locked, the one or more processing units can determine that the criterion is not satisfied and disallow receipt of any configuration information through the audio jack.

According to another aspect of the present disclosure, a computer-implemented method is disclosed in a gaming system having game-logic circuitry including one or more central processing units and one or more memory devices. The method comprises: receiving, via an input device, an input indicative of a wager on a wagering game; displaying, on a display device of a gaming machine, the wagering game; the game-logic circuitry determining a game outcome of the wagering game; providing access to an audio jack located behind a locked access door of a cabinet of the gaming machine, the audio jack having at least a microphone input conductor receiving an input from an external audio plug; responsive to a criterion being satisfied, receiving, through the audio jack, configuration information to configure multiple components of the gaming machine, the components including a hardware component and a software component both associated with the gaming machine or with a wagering game playable on the gaming machine; and responsive to receiving the configuration information through the audio jack, configuring at least some of the components according to the received configuration information.

The computer-implemented method can further comprise: the game-logic circuitry determining whether the locked access door is unlocked prior to receiving the configuration information, and responsive to the game-logic circuitry determining that the locked access door is locked, determining that the criterion is not satisfied and disallowing receipt of any configuration information through the audio jack.

The configuration information can be encoded using an audio lossy compression encoding format and contained in a single file. The method can further comprise: selecting from among a plurality of audio files each encoded using an audio lossy compression encoding format a first of the audio files, the first of the audio files encoding the configuration information, the plurality of audio files having mutually distinct sets of configuration information.

The mutually distinct sets of configuration information can differ by at least a default denomination setting or a wagering game theme. The configuring can include decoding the received configuration information into corresponding digital information indicative of a configuration setting and its associated value or parameter. The configuration information can be received through an audio cable connected to the audio jack.

The one or more components can be a plurality of components. The received configuration information can include a plurality of default settings associated with the gaming machine and a user-selectable setting. The method can further cause the game-logic circuitry to configure at least some of the plurality of components according to the default settings and to display on the one or more display devices a prompt to enter a value or a parameter for the user-selectable setting via the one or more input devices.

Additional aspects of the present disclosure will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present disclosure.

FIG. 2 is a schematic view of a gaming system according to an embodiment of the present disclosure.

FIG. 3 is an image of an exemplary basic-game screen of a wagering game displayed on a gaming machine, according to an embodiment of the present disclosure.

FIG. 4 is diagrammatic representation of an exemplary system that includes a gaming machine having an audio jack and an external device plugged into the audio jack through a locked access door of the gaming machine;

FIG. 5 is a diagrammatic representation of an exemplary audio file that includes configuration information for configuring hardware/software components of the gaming machine shown in FIG. 1 or 4;

FIG. 6 is a representation of a graphical user interface (GUI) that can be displayed on the gaming machine or the external device shown in FIG. 4, in which the operator can confirm multiple default configuration settings by making a single selection;

FIG. 7 is a representation of a graphical user interface (GUI) that can be displayed on the gaming machine or the external device shown in FIG. 4, in which the operator can select user-selectable configuration setting values or parameters; and

FIG. 8 is a flowchart for an algorithm that corresponds to instructions executed by a controller in accord with at least some aspects of the disclosed concepts.

While the present disclosure is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this present disclosure is susceptible of embodiment in many different forms, there is shown in the drawings and will herein be described in detail preferred embodiments of the present disclosure with the understanding that the present disclosure is to be considered as an exemplification of the principles of the present disclosure and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

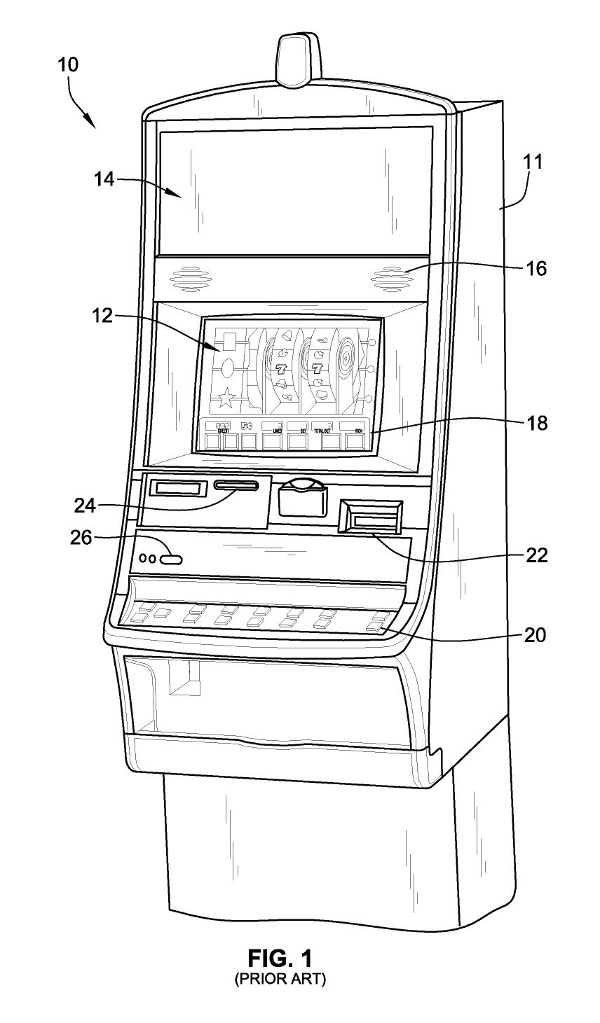

Referring to FIG. 1, there is shown a gaming machine 10 similar to those used in gaming establishments, such as casinos. With regard to the present disclosure, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in conducting wagering games, or may include non-dedicated devices, such as mobile phones, personal digital assistants, personal computers, etc. Exemplary types of gaming machines are disclosed in U.S. Pat. No. 6,517,433 and Patent Application Publication Nos. US2010/0069160 and US2010/0234099, which are incorporated herein by reference in their entireties.

The gaming machine 10 illustrated in FIG. 1 comprises a cabinet 11 that may house various input devices, output devices, and input/output devices. By way of example, the gaming machine 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

Input devices, such as the touch screen 18, buttons 20, a mouse, a joystick, a gesture-sensing device, a voice-recognition device, and a virtual-input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a game-logic circuitry for processing. The electronic data signals are selected from a group consisting essentially of an electrical current, an electrical voltage, an electrical charge, an optical signal, an optical element, a magnetic signal, and a magnetic element.

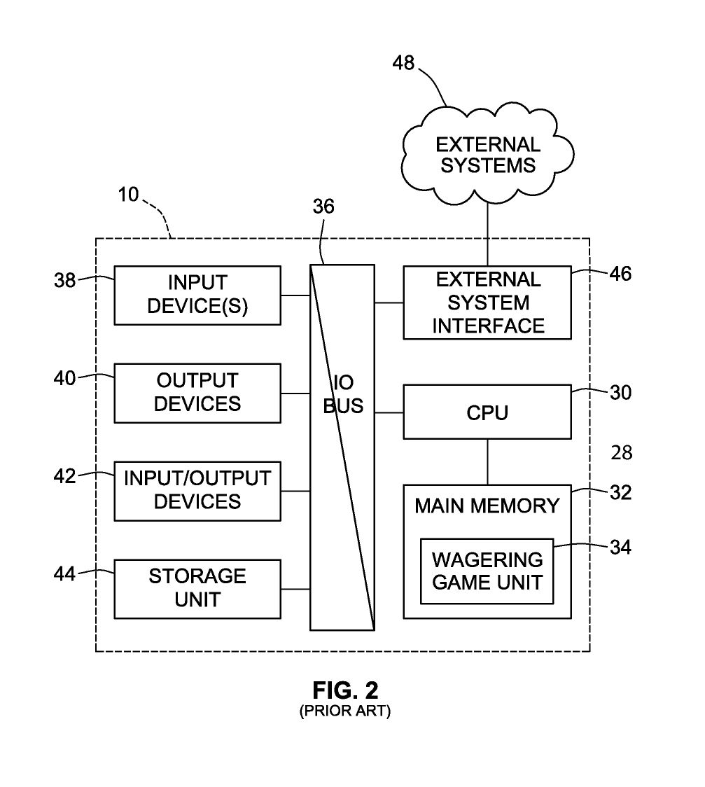

Turning now to FIG. 2, there is shown a block diagram of the gaming-machine architecture. The gaming machine 10 includes game-logic circuitry 28 having a central processing unit (CPU) 30 connected to a main memory 32. The CPU 30 may include any suitable processor(s), such as those made by Intel and AMD. By way of example, the CPU 30 may include a plurality of microprocessors including a master processor, a slave processor, and a secondary or parallel processor. Game-logic circuitry 28, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 28, and more specifically the CPU 30, comprises one or more controllers or processors and such one or more controllers or processors need not be disposed proximal to one another and may be located in different devices or in different locations. The game-logic circuitry 28, and more specifically the main memory 32, comprises one or more memory devices which need not be disposed proximal to one another and may be located in different devices or in different locations. The game-logic circuitry 28 is operable to execute all of the various gaming methods and other processes disclosed herein. The main memory 32 includes a wagering-game unit 34. In one embodiment, the wagering-game unit 34 may cause wagering games to be presented, such as video poker, video black jack, video slots, video lottery, etc., in whole or part.

The game-logic circuitry 28 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to a storage unit 44 and an external-system interface 46, which may be connected to external system(s) 48 (e.g., wagering-game networks).

The external system 48 includes, in various aspects, a gaming network, other gaming machines or terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external-system interface 46 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 48 such that the gaming machine 10 operates as a thin, thick, or intermediate client. The game-logic circuitry 28—whether located within (“thick client”), external to (“thin client”), or distributed both within and external to (“intermediate client”) the gaming machine 10—is utilized to provide a wagering game on the gaming machine 10. In general, the main memory 32 (comprising one or more memory devices) stores programming for an RNG, game-outcome logic, and game assets (e.g., art, sound, etc.). When a wagering-game instance is executed, the CPU 30 (comprising one or more processors or controllers) executes the RNG programming to generate one or more pseudo-random numbers. The pseudo-random numbers are utilized by the CPU 30 when executing the game-outcome logic to determine a resultant outcome for that instance of the wagering game. The resultant outcome is then presented to a player of the gaming machine 10 by accessing the associated game assets, required for the resultant outcome, from the main memory 32. The CPU 30 causes the game assets to be presented to the player as outputs from the gaming machine 10 (e.g., audio and video presentations).

The gaming machine 10 may include additional peripheral devices or more than one of each component shown in FIG. 2. Any component of the gaming-machine architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

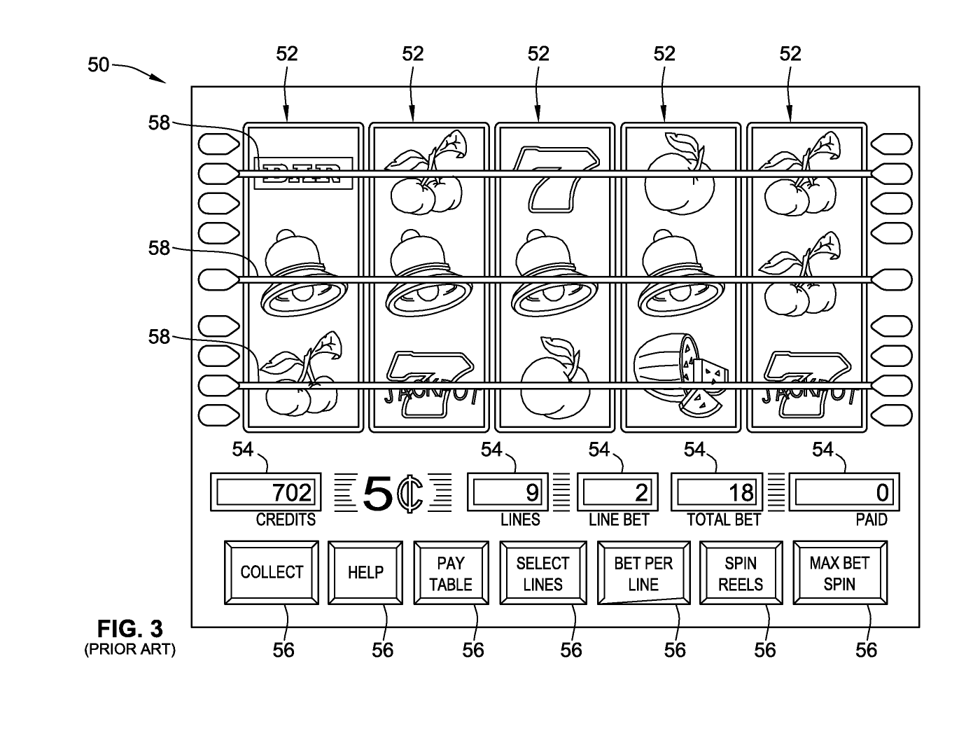

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The game-logic circuitry 28 operates to execute a wagering-game program causing the primary display area 12 or the secondary display area 14 to display the wagering game.

In response to receiving an input indicative of a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 12 or secondary display 14) through the display of information such as, but not limited to, text, graphics, static images, moving images, etc., or any combination thereof. In accord with the method of conducting the wagering game, the game-logic circuitry 28 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 28 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 30 causes the recording of a digital representation of the wager in one or more storage media (e.g., storage unit 44), the CPU 30, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU 30 (e.g., the wager in the present example). As another example, the CPU 30 further, in accord with the execution of the stored instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 28 to determine the outcome of the wagering-game instance. In at least some aspects, the game-logic circuitry is configured to determine an outcome of the wagering-game instance at least partially in response to the random parameter.

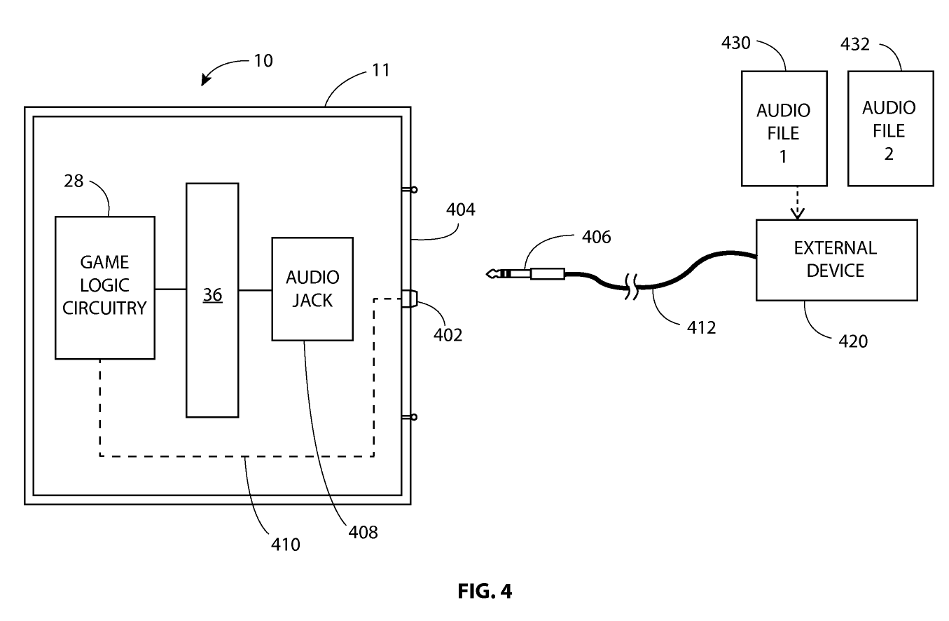

Referring now to FIG. 4, a diagrammatic illustration of the gaming machine 10 is shown in which its cabinet 11 includes a lockable access door 404 having a door lock 402. The lockable access door 404 when locked is termed a locked access door and when unlocked is termed an unlocked access door. The door lock 402 can be locked or unlocked by a mechanical key, for example, or remotely by wireless control. An optional lock status signal line 410 can be provided to the game logic circuitry 28 to indicate a status (e.g., locked, unlocked, compromised) of the door lock 402. If the door lock 402 has been compromised, such as by attempted mechanical intrusion or defeat, the lock status signal line 410 can indicate to the game logic circuitry 28 that the door lock 402 may have been compromised so that an alarm can be issued or some lockdown or lockout sequence initiated.

Behind the access door 404 resides an audio jack 408 that is accessible externally from the gaming machine 10 through the access door 404. To access the audio jack 408, the access door 404 must be unlocked via the door lock 402, and the access door 404 opened. The audio jack 408 has a microphone input conductor that receives an input from an external audio plug 406. The microphone input conductor thus permits a one-way transfer of information from an external device 420 into the game logic circuitry 28, but does not permit the game logic circuitry 28 to transmit any information back to the external device 420. In another implementation, the audio jack 408 includes both a microphone input conductor and a receiver output conductor that outputs an audio sound to the external audio plug 406. Alternately, there can be a separate output audio jack (not shown) configured for outputting audio sounds, and a separate audio cable (not shown) can be connected to the external device 420 for receiving audio signals from the gaming machine 10 at the external device 420. As described below, when two-way communication is allowed through the audio jack 408, it is possible for the gaming machine 10 to send information back to the external device 420 through the audio jack 408. For enhanced security, a one-way communication can be used to disallow any transfer of information from the gaming machine 10 to the external device 420. The external device 420 can be, for example, a portable computer, such as a smartphone or a tablet computer, or another gaming machine like the gaming machine 10, or any other human-portable or standalone (non-portable) device having a computer (or a central processing unit) and audio output capability, such as a server computer or an audio player.

Generally speaking, configuration information is communicated from the external device 420 through the audio jack 408 into the game logic circuitry 28 to configure one or more hardware or software components or hardware and software components of the gaming machine 10. A criterion can be evaluated by the game logic circuitry 28 to determine whether the configuration information is permitted to be received through the audio jack 408. For example, the criterion can include plugging the external audio plug 406 into the audio jack 408. That action alone can suffice to initiate a transfer of the configuration information from the external device 420 to the gaming machine 10. Another example criterion can include whether the optional lock status signal line 410 indicates that the status of the door lock 402 is locked or unlocked. If the door lock 402 status is unlocked, the lock status signal line 410 indicates to the game logic circuitry 28 that the door lock 402 is unlocked, and the game logic circuitry 28 proceeds to allow the configuration information to be received through the audio jack 408 of the gaming machine 10. Yet another example criterion is selecting a button or other selectable element via an input device on the external device to initiate the transfer on the external device 420.

Preferably, the external device 420 can be connected to the audio jack 408 by a physical audio cable 412. The audio cable 412 can provide enhanced security relative to wireless methods of communicating the configuration information between the external device 420 and the gaming machine 10. However, wireless communication methods are not precluded by the present disclosure. The configuration information can be communicated wirelessly using an audio protocol, but only when the door lock 402 is unlocked. In this example, if the lock status signal line 410 indicates that the door lock 402 is unlocked, the game logic circuitry 28 permits configuration information to be received through the audio jack 408, which in this example can be a wireless interface, such as a Bluetooth interface. Another wireless interface can include an audio speaker that outputs the configuration information as an audio signal, and a corresponding microphone inside the cabinet 11 that receives the audio signal corresponding to the configuration information. The microphone can be configured so that it can only receive audio signals outside the cabinet 11 when the door 404 is ajar and the door lock 402 is unlocked.

As discussed, for enhanced security, a physical audio cable 412 can be connected between the audio jack 408 and the external device 420. The audio jack 408 is conventionally coupled to an audio driver circuit, which according to this disclosure, advantageously can always be “listening” for an input to be received through the audio jack. Once the external audio plug 406 is plugged into the audio jack 408, the audio driver circuit automatically recognizes the presence of an input device and begins to accept and forward any incoming audio signal to the game logic circuitry 28.

The configuration information according to the present disclosure is modulated according to frequencies that correspond to the human-audible sound spectrum, which is conventionally between 20 Hz-20 kHz. Without limiting the present disclosure to any particular modulation schema, an example includes representing a digital 0 with a very low frequency signal, such as 20 Hz, while representing a digital 1 with a relatively high frequency signal, such as 20 kHz. Alternately, amplitude modulation can be used to represent different digital bits, or a combination of amplitude and frequency modulation can be used. Instead of encoding individual digital bits into the modulation, digital words, such as bytes, can be modulated. With such a relatively wide frequency spectrum available, the unique permutations of digital word combinations possible are limited only by the sensitivity of the receiving circuitry to discern distinct amplitudes and/or frequencies. Those skilled in the art will readily appreciate that any number of techniques are available for representing digital bits of information in an audio signal. The configuration information can be further encoded using an open or proprietary audio lossy compression encoding format, such as the popular MP3 format or a proprietary format, and can be contained in a single file, as that term is understood in the computer art. A high bitrate but low baud rate can be used for encoding and transferring the configuration information reliably in an error-free manner. As explained below, different sets of configuration settings can be stored in separate audio files for selection by the installer or operator to facilitate or streamline configuring multiple gaming machines on a floor, such as of a casino. The external device 420 decodes the audio file using an audio player, such as an MP3 decoder, and the corresponding modulated sound is transferred in an analog or digital form securely through the shielded audio cable 412 to the audio jack 408 into which the external audio plug 406 is plugged. The audio driver coupled to the audio jack 408 automatically receives and forwards the received sound to the game logic circuitry 28, which demodulates the incoming sound signals into digital information corresponding to configuration settings and their respective values or parameters.

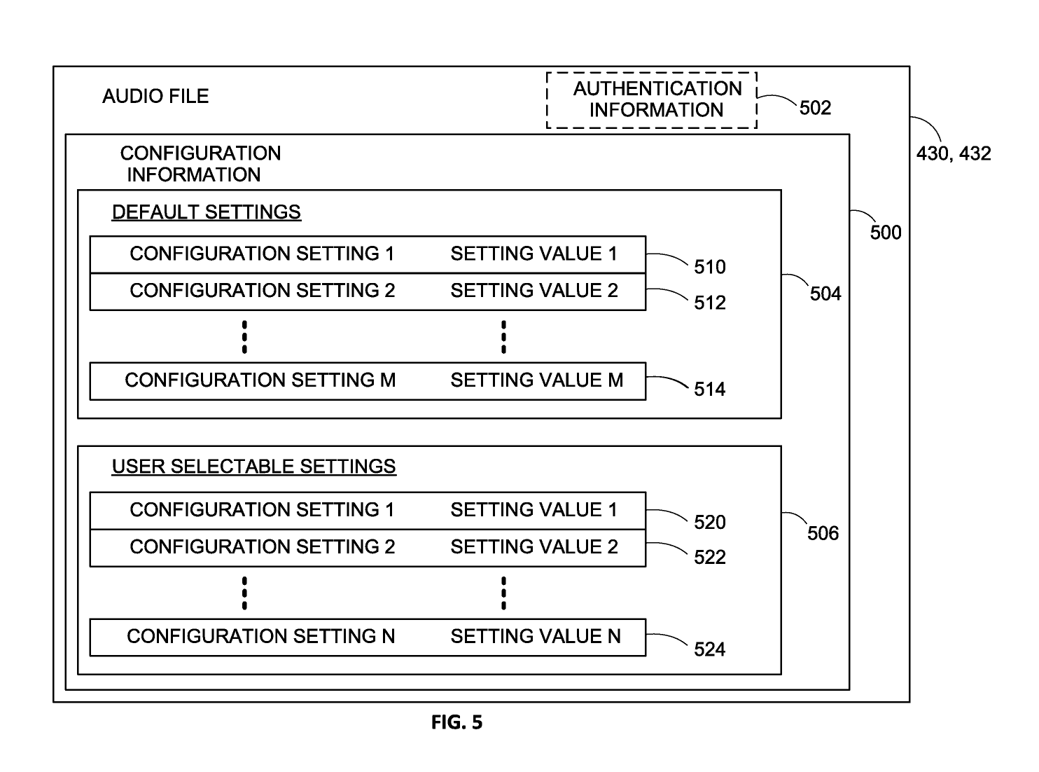

In FIG. 4, two exemplary audio files 430, 432 are shown. The operator or installer can select among multiple audio files 430, 432, each of which contain a different combination of configuration settings, which can be a combination of default settings and user-selectable settings. FIG. 5 is a diagrammatic representation of an exemplary audio file 430, 432 that includes configuration information for configuring hardware/software components of the gaming machine 10. Optional authentication information 502 can be embedded into the audio file 430, 432, such as a digital signature or a key, as those terms are understood in the field of encryption, to allow the gaming machine 10 to verify that the configuration information has been received from a trusted source or to decrypt the encrypted configuration information using a key supplied in the authentication information 502.

The audio file 430, 432 also includes the configuration information, which in this example, includes both default settings 504 and user-selectable settings 506. Alternately, the configuration information can contain default settings only or user-selectable settings only. The default settings 504 include M number of configuration settings 510, 512, 514 and their corresponding setting values or parameters. The user-selectable settings 506 include N number of configuration settings 520, 522, 524 and their corresponding setting values or parameters.

Examples of configuration information include configuration parameters or settings that affect the operation of a hardware or software component of a wagering game machine, such as the gaming machine 10, or the wagering game(s) presented on the gaming machine 10. Examples of such configuration information that can be stored on a wagering game machine, such as the gaming machine 10, include one or more of the following settings:

Line count: The number of lines of symbols to be displayed on a wagering game machine.

Paylines: The lines in a matrix of symbols that may be used to determine a winning combination of symbols. The paylines may be defined to be straight, horizontal, vertical, diagonal, or may take an arbitrarily defined path through the symbols.

Themes: Images, audio, and video content that describe a theme for the wagering game machine. For example, a wagering game theme may based on a television show or board game.

Bonus rounds: Content, including software, audio, image, and video content that provides a bonus round when triggered by a wagering game.

Episodic Content: Content associated with episodes of a bonus round or wagering game.

Attract Content: Content (images, audio and/or video) presented when the wagering game machine is idle (i.e., in “attract” mode) to attempt to attract players to the machine.

Denomination: The amount required for a single game play (e.g., 5 cents, 10 cents, 1 dollar, 5 dollars etc.).

Pay tables: Tables that determine the wagering game machines payout upon the occurrence of various combinations of symbols, cards, dice, numbers, etc.

Max wager amount: The maximum amount that may be wager on any single round of wagering game play.

Jackpot Limit (aka Hand Pay Limit): The award amount at which the machine requires a human to pay the award on the machine's behalf.

Ticket parameters: Operator-configurable values that are printed on payout tickets, such as casino name, expiration date, etc.

Time zone: The time zone of the geographic location where the wagering gaming machine sits.

Currency type settings: The type of currency, e.g., U.S. Dollar, Australian Dollar, Euro, and the like, accepted by the wagering game machine.

Progressive Game: Determines which, if any, progressive game the wagering game machine participates in.

Play Mechanics: Determines aspects of how the wagering game may be played or presented. Examples of aspects include cascading reels, free spins, line combinations and other aspects of a wagering game definition.

Video Card: Specifies how the video card of the gaming machine 10 for one of the displays, such as 12, 14, is to drive each display, such as a screen resolution or whether a rendering engine of the video card is to be enabled or disabled.

Communication: Specifies how the external system interface 46 communicates with external systems 48, such as communication protocol, baud rate, or transmission rate.

Configuration information is distinct from content information, such as the audio or video content used to present or portray the wagering game on the gaming machine 10. For example, configuration information can affect how the audio or video content is presented or portrayed but does not itself represent actual content that is presented or portrayed. A gaming machine 10 has multiple hardware components and software components, and each of these components can be configured so that they operate in a particular way.

Returning to FIG. 4, once the configuration information has been received in its entirety from the external device 420 through the audio jack 408, and optionally authenticated using the optional authentication information 502 embedded in the received configuration information, at least some of the affected components are configured according to the received configuration information. For example, as described below, when default settings are to be applied to selected components, they are automatically configured according to the received default settings. Other settings can be user-selectable, which will be discussed next with reference to a couple of example displays.

FIG. 6 illustrates a graphical or diagrammatic graphical user interface (GUI) 600 that can be displayed on the display 12, 14 or on a video display device of the external device 420. The layout and wording can vary, but this illustration is to simply make the point that the user can confirm a number of default settings in bulk by selecting a single confirmation button 608. In this example, the configuration information includes one or more default configuration settings or only default configuration settings (and no user-selectable settings) extracted from the received audio file 430, 432, which settings can be displayed in a first area 604 along with their corresponding setting values or parameters in a second area 606 so that the operator can view all of the default settings that are being configured once the operator confirms by selecting a selectable element 608 (e.g., a graphical button labeled “Yes” or “Confirm” or “Accept” the like) via a touchscreen, a mouse, a keyboard, or using an input device, such as the input device 38, or an input device on the external device 420, such as a touchscreen, keyboard, mouse, or the like. The operator can also be presented with an option to reject the default settings by selecting a second selectable element 610 (e.g., a graphical button labeled “No” or “Reject” or the like) via the same input device. The software or firmware for presenting this graphical user interface can be executed by the CPU 30 or by a CPU in the external device 420. If the default configuration settings are accepted, the affected hardware and/or software components are automatically configured accordingly by the gaming machine 10.

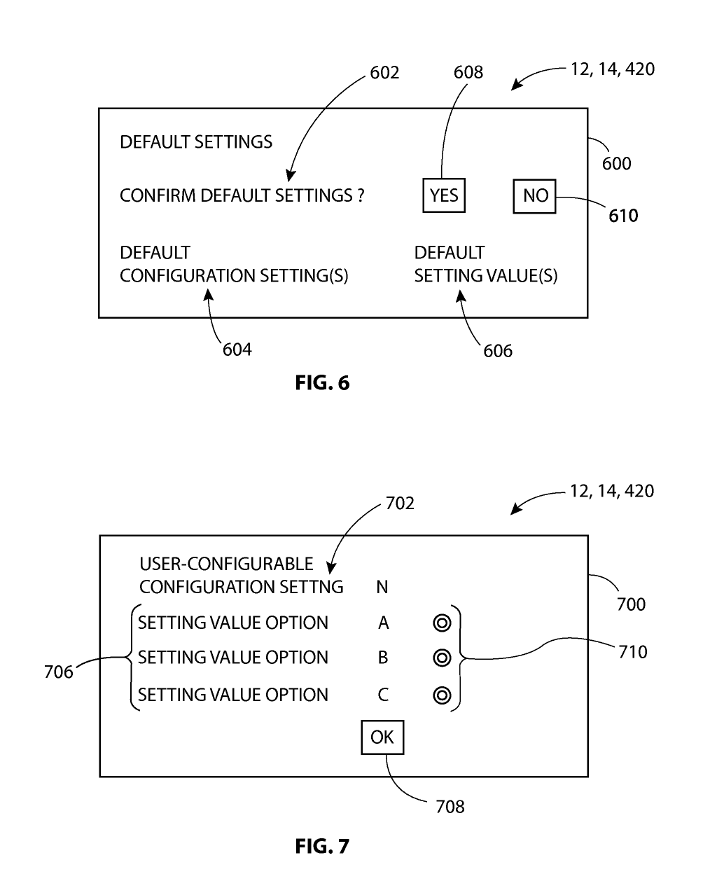

FIG. 7 illustrates a graphical or diagrammatic GUI 700 that can be displayed on the display 12, 14 of the gaming machine 10 or on a video display device of the external device 420. The layout and wording can vary, but this illustration shows a user-selectable (or user-configurable) configuration setting (such as the configuration setting N shown in FIG. 5) extracted from the received audio file 430, 432 along with various setting value options that can be selected by the operator after the configuration information has been transferred into the game logic circuitry 28 via the audio jack 408. The user-selectable configuration setting (e.g., “Denomination” or wagering game “Theme”) is displayed in a first area 702 of the GUI 700, along with multiple setting value or parameter options (labeled generically A, B, C) in a second area 706 of the GUI 700. Selection elements, such as radio buttons, are shown graphically in a third area 710 of the GUI 700. For example, setting values or parameters A, B, C 706 can be 5 cents, 10 cents, or 25 cents. The operator makes a selection of one of the values 710, using an input device 38 via the gaming machine or via the external device 420, and then confirms the selection by selecting selectable element 708, such as a graphical button labeled “Yes,” “OK,” “Confirm,” “Accept,” or the like. Once the configuration setting is accepted, the affected hardware or software component is automatically configured accordingly by the gaming machine 10.

Referring to the GUI representations 600, 700 shown in FIGS. 6-7, if the GUI representations 600, 700 are shown on a display of the external device 420, the external device 420 can be configured or operable to convert any inputs received via an input device (such as a touchscreen) associated with the external device 420 into corresponding audio signals that are transmitted through the cable 412 to the audio jack 408 of the gaming machine 10, which in turn converts the received audio signals into digital signals indicative of the input received at the external device 420. The received audio signals indicate at least the configuration setting and its corresponding setting value or parameter. The game logic circuitry 28 adjusts the setting value or parameter of the associated configuration setting using the converted digital signals. In implementations in which the communication between the audio jack 408 and the external device 420 is bidirectional, such that the audio jack 408 has not only a microphone conductor but also a separate receiver conductor for outputting sound, the game logic circuitry 28 can send data back to the external device 420 using the receiver part of the cable 412 in the form of audio signals that are then correspondingly demodulated and/or decoded by the external device 420 to interpret the information contained in the audio signals from the gaming machine 10 in the same or similar manner that the game logic circuitry 28 interprets audio information received from the external device 420. For example, when the operator selects the selectable element 708 (“OK” button) via an input device associated with the external device 420, the external device 420 converts the selected setting value or parameter into a corresponding audio signal, which is communicated through the audio cable 412 to the audio jack 408 of the gaming machine 10. The gaming machine 10, in turn, can send an acknowledgement as an audio signal back to the external device 420 through the audio cable 412 that the configuration setting and setting value or parameter transmitted from the external device 420 was received and correspondingly adjusted by the gaming machine 10.

Once the transfer of the configuration information has been completed, the operator can unplug the audio plug 406 from the audio jack 408, close the access door 404 to the gaming machine 10, and then lock the lock 402. When present, the lock status signal line 410 informs the game logic circuitry 28 that the door lock 402 is locked, thereby allowing the gaming machine to resume its usual operations.

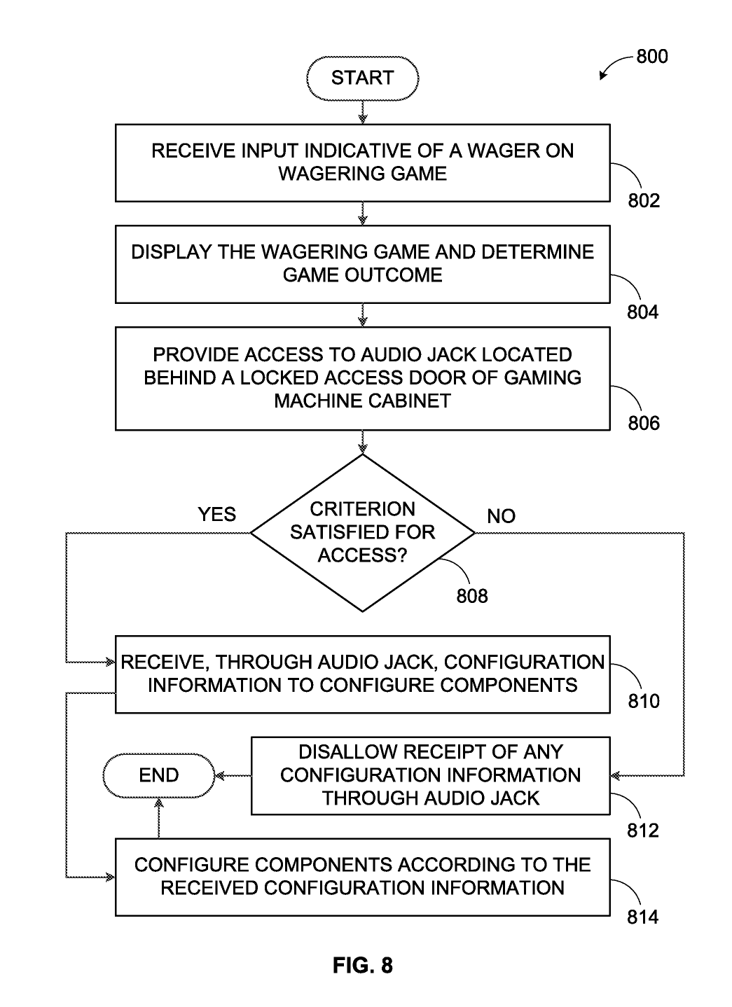

FIG. 8, described by way of example herein, represents an algorithm or a computer-implemented method 800 that corresponds to at least some machine-readable instructions stored and executed by the game-logic circuitry 28 in FIG. 2 to perform the above described acts associated with the disclosed concepts.

The algorithm 800 receives, via an input device such as the input device 28, an input indicative of a wager on a wagering game (802). The wagering game is displayed on a display device, such as the display 12, 14, of the gaming machine 10, and the game-logic circuitry determines a game outcome of the wagering game (804). These acts can be performed in any order, despite how they are introduced in FIG. 8.

The game-logic circuitry 28 provides access to an audio jack 408 located behind a locked access door 404 of a cabinet 11 of the gaming machine 11 (806). As described above, the audio jack 408 has a microphone input conductor receiving an input from an external audio plug 406 and optionally a receiver output conductor for outputting a sound to the external audio plug 406.

The algorithm 800 checks whether a criterion to allow transfer of the configuration information has been satisfied (808). Examples of suitable criteria are described above. In this example, the criterion can be whether the lock status signal line 410 indicates that the door lock 402 is unlocked, when the gaming machine 10 is configured to indicate the locked or unlocked status of the door lock 402.

If the criterion required for access is satisfied (808), the gaming machine 10 receives, through its audio jack 408, configuration information to configure hardware or software or both hardware and software components of the gaming machine associated with the gaming machine or with the wagering game playable on the gaming machine (810). If the audio jack 408 is configured as a microphone input only, this communication is a one-way transfer from the external device 420 such that the gaming any audio signals that may be transferred back through the cable 412 are either ignored by the external device 420 or are prevented from being outputted through the driver associated with the audio jack 408 by the game logic circuitry 28.

Once all of the configuration information has been received by the game logic circuitry 28, the game logic circuitry 28 of the gaming machine 10 configures at least some of the gaming machine components according to the received configuration information (814). However, if the criterion required for access is not satisfied (808), the algorithm 800 disallows receipt of any configuration information through the audio jack 408 (812). Alternately and equivalently, the algorithm 800 refrains from taking any action to cause any configuration information to be transferred from the external device 420 (812).

Aspects of the present disclosure can be used to quickly and easily configure a large number of gaming machines on a floor without having to retrofit each gaming machine or add any hardware thereto. Most if not all gaming machines have an audio jack, and appropriate software or firmware according to the algorithms and methods described herein is loaded into the gaming machine 10. Some legacy gaming machines lack, for example, a USB port, so as long as they have an input audio jack, the aspects described herein can be implemented on such legacy machines. If the external device 420 is a smartphone, the gaming machine manufacturer can supply an application, commonly known as an app, to be used by the operators on their smartphones for configuring each gaming machine. The operator first selects one of multiple audio files 430, 432, which can be MP3 files, depending on the gaming machine or group of gaming machines to be configured. The audio files 430, 432 can be stored on the external system 48, such as a cloud server or a music server, and they can be accessible, for example, by the operator's logging into a secure web browser login page using a web browser on the operator's smartphone or other external device 420. The operator unlocks the lock 402 of a first gaming machine, plugs in the audio plug 406 connected to the external device 420 into the audio jack 408 of a first gaming machine, and proceeds to transfer a first set of configuration settings and their corresponding setting values or parameters to the first gaming machine. When the transfer has been completed, the operator can, using a GUI such as described and shown in FIGS. 6 and 7, confirm settings or adjust user-selectable settings for the first wagering game. The operator locks the lock 402 of the first gaming machine, and moves to the next gaming machine, and repeats this process until all gaming machines in the group of gaming machines to be configured have been configured. Using the default configuration settings, most of the configuration settings can already be established upon a successful transfer of the configuration information to each of the gaming machines, so all the operator needs to do is optionally configure a few user-selectable settings for at least some of the gaming machines.

Alternately, before transferring the configuration information to a gaming machine, the operator can be provided an interface, such as a webpage, that displays all of the configuration settings and their corresponding values or parameters to the operator. The operator can configure the settings via the webpage, save the settings in the configuration information, which is then converted into an audio file for transferring to the gaming machine. In this implementation, no user-selectable settings need to be adjusted once the transfer is complete. Desirably, the configuration of multiple gaming machines according to aspects of the present disclosure can be carried out without having the operator drill through multiple menus, which causes confusion and leads to errors.

Certain configuration settings on a gaming machine can be protected so that they can never be adjusted through the audio jack 408. For example, the payout percentage can be protected from being changed by any setting received from the external device 420.

Each of these embodiments and obvious variations thereof is contemplated as falling within the spirit and scope of the claimed invention, which is set forth in the following claims. Moreover, the present concepts expressly include any and all combinations and sub-combinations of the preceding elements and aspects.

The above are examples of configuration data that may be maintained by a wagering game machine. Those of skill in the art will appreciate that other types of configuration data may be maintained and such configuration data is within the scope of the inventive subject matter.

What is claimed is:

1. A gaming machine, comprising:
a cabinet having a locked access door;
one or more input devices;
one or more display devices;
an audio jack accessible externally from the gaming machine through the locked access door, the audio jack having at least a microphone input conductor receiving an input from an external audio plug;
game-logic circuitry, comprising one or more central processing units and one or more memory devices, the one or more memory devices storing non-transitory machine-readable instructions that, when executed by the one or more central processing units, cause the game-logic circuitry to:
receive, via at least one of the one or more input devices, an input indicative of a wager;
responsive to a criterion being satisfied, receive, through the audio jack, configuration information from a device external to the gaming machine to configure one or more components of the gaming machine, the components including a hardware component and a software component both associated with the gaming machine or with a wagering game playable on the gaming machine; and
responsive to receiving the configuration information through the audio jack, configure the one or more components according to the received configuration information.

2. The gaming system of claim 1, wherein the configuration information is encoded using an audio lossy compression encoding format and contained in a single file.

3. The gaming system of claim 1, wherein the game-logic circuitry allows the configuration information to be received through the audio jack but no information can be transmitted to the gaming machine from an external device that sent the configuration information during the configuration of the hardware or software component.

4. The gaming system of claim 1, wherein the configuration information is received through an audio cable connected to the audio jack.

5. The gaming system of claim 1, the one or more central processing units further causing the game-logic circuitry to display on the one or more display devices a configuration setting associated with the received configuration information and a prompt to enter a value or a parameter for the configuration setting via the one or more input devices.

6. The gaming system of claim 1, wherein the configuration information includes a configuration setting and a corresponding value or parameter associated with the configuration setting, wherein the configuration setting includes a line count setting indicating a number of lines of symbols to be displayed on the wagering game, a payline setting indicating lines in a matrix of symbols of the wagering games used to determine winning combinations of symbols, a theme setting indicating a theme of the wagering game, a bonus round setting indicating content to be provided when the wagering game triggers a bonus round, an episodic content setting indicating content associated with episodes of a bonus round of the wagering game or of the wagering game, an attract content setting indicating content to be presented when the wagering game is idle to attract players to the gaming machine, a denomination setting indicating an amount of a wager required for a single game play of the wagering game, a pay table setting indicating a table to determine a payout of the wagering game responsive to a game outcome of the wagering game corresponding to a winning outcome, a maximum wager amount setting indicating a maximum amount of the wager on a round of game play of the wagering game, a progressive game setting indicating which progressive game the wagering game participates in, or a play mechanic setting indicating a presentation of aspects of how the wagering game is to be played.

7. The gaming system of claim 1, wherein the one or more components includes a plurality of components, and wherein the received configuration information includes a plurality of default settings associated with the gaming machine and a user-selectable setting, the one or more central processing units further causing the game-logic circuitry to configure at least some of the plurality of components according to the default settings and to display on the one or more display devices a prompt to enter a value or a parameter for the user-selectable setting via the one or more input devices.

8. The gaming system of claim 1, the one or more central processing units further causing the game-logic circuitry to determine whether the locked access door is unlocked prior to receiving the configuration information, and responsive to the game-logic circuitry determining that the locked access door is locked, determine that the criterion is not satisfied and disallow receipt of any configuration information through the audio jack.

9. A computer-implemented method in a gaming system having game-logic circuitry including one or more central processing units and one or more memory devices, the method comprising:
receiving, via an input device, an input indicative of a wager on a wagering game;
displaying, on a display device of a gaming machine, the wagering game;
the game-logic circuitry determining a game outcome of the wagering game;
providing access to an audio jack located behind a locked access door of a cabinet of the gaming machine, the audio jack having at least a microphone input conductor receiving an input from an external audio plug;
responsive to a criterion being satisfied, receiving, through the audio jack, configuration information to configure multiple components of the gaming machine, the components including a hardware component and a software component both associated with the gaming machine or with a wagering game playable on the gaming machine; and
responsive to receiving the configuration information through the audio jack, configuring at least some of the components according to the received configuration information.

10. The computer-implemented method of claim 9, further comprising:
the game-logic circuitry determining whether the locked access door is unlocked prior to receiving the configuration information, and responsive to the game-logic circuitry determining that the locked access door is locked, determining that the criterion is not satisfied and disallowing receipt of any configuration information through the audio jack.

11. The computer-implemented method of claim 9, wherein the configuration information is encoded using an audio lossy compression encoding format and contained in a single file, the method further comprising:
selecting from among a plurality of audio files each encoded using an audio lossy compression encoding format a first of the audio files, the first of the audio files encoding the configuration information, the plurality of audio files having mutually distinct sets of configuration information.

12. The computer-implemented method of claim 11, wherein the mutually distinct sets of configuration information differ by at least a default denomination setting or a wagering game theme.

13. The computer-implemented method of claim 9, wherein the configuring includes decoding the received configuration information into corresponding digital information indicative of a configuration setting and its associated value or parameter.

14. The computer-implemented method of claim 9, wherein the configuration information is received through an audio cable connected to the audio jack.

15. The computer-implemented method of claim 9, wherein the one or more components includes a plurality of components, and wherein the received configuration information includes a plurality of default settings associated with the gaming machine and a user-selectable setting, the method further causing the game-logic circuitry to configure at least some of the plurality of components according to the default settings and to display on the one or more display devices a prompt to enter a value or a parameter for the user-selectable setting via the one or more input devices.
